(19) United States
(12) Patent Application Publication
(10) Pub. No.: US 2005/0233141 A1
(43) Pub. Date: Oct. 20, 2005

(54) Optical disc having lenticular surface and method of manufacturing

(76) Inventors: Kent Christian Johnson, Newport Coast, CA (US); Stephen L. Burnett, Irvine, CA (US)

Correspondence Address: STETINA BRUNDA GARRED & BRUCKER, 75 ENTERPRISE, SUITE 250, ALISO VIEJO, CA, 92656, US

(21) Appl. No.: 10/927,209

(22) Filed: Aug. 26, 2004

Related U.S. Application Data
(63) Continuation-in-part of application No. 10/827,010, filed on Apr. 19, 2004.

(51) Int. Cl. G11B 7/24

(52) U.S. Cl. 428/364

(57) ABSTRACT

The optical disc of the present invention includes a first translucent substrate having generally planar opposed top and bottom surfaces. The bottom surface is smooth and adapted to an optical beam for accessing data on the disc. The top surface of the first substrate has formed pits that represent data recorded on the disc or alternatively has a photo-reactive chemical formed thereon. A reflective coating is formed on the top data surface or photo-reactive chemical surface of said first substrate to enable the top surface to reflect light back to an optical reader. A bonding agent is disposed over the reflective coating and a second substrate is bonded to the first substrate though hot melt bonding or UV bonding. The second translucent substrate has a top surface incorporating a plurality of lenticules formed therein, and a bottom surface having an interlaced segmented lenticular image printed thereon. The method of the present invention provides that the top substrate incorporating lenticular imagery is hot melt bonded or UV bonded through use of a bonding agent to a bottom substrate bearing recorded data and a metalized layer for reflecting optical beams.

### CROSS-REFERENCE TO RELATED APPLICATIONS

The present application is a continuation in part of U.S. patent application Ser. No. 10/827,010 filed Apr. 19, 2004, the substance of which is incorporated herein by reference.

### STATEMENT RE: FEDERALLY SPONSORED RESEARCH/DEVELOPMENT

Not Applicable

### BACKGROUND OF THE INVENTION

The present invention relates generally to an optical data disc having opposed data and lenticular substrates and a method of manufacturing the same. More particularly, the present invention comprises a novel CD or DVD configuration that comprises the data substrate bonded with the substrate forming a lenticular image for providing a visually stunning but functional data disc that also provides increased durability and may provide identification of authentic products (i.e. anti-counterfeiting protection).

Replication methods of Digital Versatile Discs (DVD) and Compact Discs (CD) are well known. Several processes are currently used; however, the most efficient and widely used manufacturing process for CDs and DVDs at the current time is the standard stamper-injection molding process. While the process of creating a DVD verses a CD is slightly different for the stamper-injection molding process, both processes share basic common components. In both fabrication processes, following the creation of a master recording of data, a glass master is created using a laser beam recording technique. From the glass master, a metallization process forms an electroformed stamper that will be used in pressing discs in an injection molding disc replication process.

The replication process specific for a DVD, and in particular a DVD-5 is shown in flow-chart format in FIG. 1. The stamper 10 is used in the injection mold. A polycarbonate material (or other suitable plastic) is forced into the injection mold in the injection molding step 12 and a disc having a data surface is created. The DVD and CD injection molding process is similar but have the following important differences: Two pressings are typically used for DVDs; and the resulting DVD data half disc is 0.6 mm thick and the CD is 1.2 mm thick. During the cooling process the center hole is punched. Because CD and DVD players are incapable of reading the data from the substrate directly, the disc must be made reflective by adding a metalized layer. A reflective coating 14, such as aluminum, is added to the data surface. A reflective coating of 70 to 90 percent is desired, and as such, it is preferred that the layer of aluminum be 50 to 100 mm thick. The coating can be achieved by a number of methods, including but not limited to, vacuum evaporation or cathode sputtering. Thus, a readable, half data disc 16 is fabricated for further processing.

The DVD half data disc 16, in this state, is vulnerable as the aluminum surface is exposed to the environment. Accordingly, a second layer to the disc is added to protect and finish the disc. A second dummy disc is injection molded 18 to create a blank disc 20. The blank disc 20 is then bonded 22 to the aluminum surface side of the data disc 16 using a hot melt bonding process. In the creation of a DVD-9 disc or DVD-10, a second data disc is hot melt bonded to the data half disc. When creating a CD, because of the full thickness of the disc, the aluminum surface is protected by a lacquer that is spread evenly across the aluminum surface. This protects the aluminum and provides a surface that may be finished with a label or screen printing. Although the lacquer is provided for protection, the layer is only millimeters thick and susceptible to scratching which may damage the underlying data surface and aluminum coating, rendering portions of the disc unreadable.

Once the layered disc has been finished, it is properly inspected 24 for defects. Once the disc passes inspection, the upper surface, in the case of DVD-5s the top surface of the blank disc (and in CDs the lacquered surface) is typically printed with up to six colors by a flat silk screen process. Offset printing, for higher quality artwork on the disc surface may be utilized. Once printed, the disc is complete and is packaged as a finished product 28.

Referring particularly to FIG. 2, there is shown a cross-section of a finished DVD-5 disc 30. The bottom substrate 32 is an injection molded translucent polycarbonate having a smooth bottom surface 34 and a pitted data surface 36. The pitted data surface 36 includes the metalized layer of aluminum 38 which provides a reflective surface so that a laser 40 (shown in phantom; see FIG. 4) can project light through the translucent substrate 32 onto the pitted surface 36 and reflect the data back to an optical reader (not shown). A bonding agent 42 is sandwiched between the polycarbonate substrate 32 and the blank disc substrate 44. The substrate 32 and 44 are hot melt bonded using a bonding agent 42. The substrate 44 protects the aluminum layer of 38 from being exposed to the elements and additionally provides a surface for a label 46. A label 46 provides art work or other information, and it typically applied to the substrate 44 once the disc 30 is completed through a screen printing process or other adhesive type label process.

Referring particularly to FIG. 3, there is shown a cross-section of a typical finished CD optical disc 48. A polycarbonate injection molded substrate 50 includes a smooth lower surface 52 and a pitted data surface 54. The pitted surface 54 is metalized with aluminum reflective coating 56. The translucent substrate 50 and the reflective coating 56 allow for a laser 58 (shown in phantom; see FIG. 4) to project through the substrate into the aluminum coating 56 and reflect a signal back to an optical reader (not shown). A lacquer coating 60 is spun across the aluminum coating 56 to provide protection and a printing surface for label 62. A printing process such as silk screening or other adhesive label is utilized in finishing the disc 48. Again, due to the relative thickness of the lacquer coating, the data side of the CD is susceptible to damage.

Referring particularly to FIG. 10, there is shown a cross section of a typical finished CD-R optical disc 120. A polycarbonate injection molded substrate 122 includes a smooth lower surface 124 and a smooth data surface 126, a dye coating 128 which is a photo-reactive chemical, namely a polymer dye. The dye polymer 128 bonds with the polycarbonate substrate 122. The dye polymer 128 is typically applied to the data surface 126 by spin coating. The dye 128 is cured to insure that it is adhered to the polycarbonate base 122. In order to properly reflect laser light 130, an aluminum layer 132 is applied over the dye 128. Other metals used on this layer can include gold, silver and copper. Aluminum is typically the most cost efficient and widely used metal for this purpose. The translucent substrate 122 and the reflective aluminum coating 132 allow for a laser light 130 (shown in phantom) to project through the substrate 122 to the aluminum coating 132 and reflect a signal back to an optical reader (not shown). A lacquer coating 134 is spun across the aluminum coating 132 to provide protection as a printing surface for a label 136. A printing process such as silk screening or other adhesive label processes are utilized in finishing the disc 120. Again, due to the relative thickness of the lacquer coating 134, the data side of the CD-R is susceptible to damage. In operation, the laser light 130 in addition to reflecting a signal back to an optical reader (not shown) may also record data in the polymer dye 128 by a photo-reaction to a specific light signal. In this way, the CD-R can be “burned” with data.

Referring particularly to FIG. 11, there is shown a cross section of a typical finished CD-RW optical data disc 138. A polycarbonate injection molded substrate 140 includes a smooth lower surface 142 and a smooth data surface 144. The data surface 144 is layered with a dielectric 146 (zinc sulfide and silicon dioxide). Above the dielectric layer 146, a layer of phase change alloy recording layer 148 (indium, silver, tellerium and antimony) is placed. Above the phase change recording layer 148, a second dielectric layer 150 is provided. The chemical layers 146, 148 and 150 are coated with a thin aluminum reflective layer 152. A protective lacquer overcoat 154 is provided to serve as a base for a label 156. The translucent substrate 140 and the reflective coating 152 allow for a laser 158 (shown in phantom) to project through the substrate 140 and to reflect a signal back to an optical reader (not shown) or to create a photo-reaction in the chemicals 146, 148 and 150 to either burn data onto the CD, or erase data.

Although the present technology provides an economical and effective means of producing optical discs, both the CD and DVD-5 manufacturing processes do not provide a satisfactory platform for the inclusion of stunning visual graphics. Because the current manufacturing processes allow for only screen printing and other two dimensional methods of imprinting the DVDs and CDs, the art work utilized on these CDs is typically unremarkable and does not adequately reflect the creativity and boldness of the artist's recorded music. Thus, there is a great need in the art for a process for manufacturing DVDs and CDs that will allow modern graphic techniques to be used on the non-readable DVD and CD surface. Furthermore, there is a great need in the art for a DVD and CD manufacturing process that will allow the creation and inclusion of graphics that are difficult to reproduce, and thus provide counterfeit protection for the DVDs and CDs. There is also a great need in the art for a method of manufacturing CDs which provides a more durable label-side surface.

### BRIEF SUMMARY OF THE INVENTION

The present invention comprises a novel CD or DVD configuration, and method of manufacture, that comprises a data substrate bonded with a substrate forming a lenticular image for providing a visually stunning data disc. In addition, the CD or DVD is completely functional and provides the added benefit of increased durability over conventional CDs and DVDs. Also, intricate artwork can be used as the featured artwork in packaging for the disc, as well as providing anti-counterfeiting protection for the copyrighted work embodied in the CD or DVD due to the inaccessibility of the artwork which is formed below the surface, and the difficulty in reproducing the lenticular images.

Structurally, the optical disc of the present invention includes a first translucent substrate having generally planar opposed top and bottom surfaces. The bottom surface is smooth and adapted to an optical beam for accessing data on the disc. The top surface of the first substrate has formed pits that represent data recorded on the disc. A reflective coating is formed on the top data surface of said first substrate to enable the top surface to reflect light back to an optical reader. A bonding agent is disposed over the reflective coating and a second substrate is bonded to the first substrate through hot melt bonding or UV bonding. The second translucent substrate has a top surface incorporating a plurality of lenticules formed therein, and a bottom surface having interlaced strips of images forming the lenticular image printed thereon.

In the method of the present invention, a lenticular optical data disc is fabricated by providing a data substrate having generally planar opposed top and bottom surfaces. The data substrate includes a bottom surface for receiving an optical beam, and said top surface has a formed pitted surface representing recorded data. Next, a lenticular substrate is provided which has generally planar top and bottom surfaces, with the top surface having a plurality of lenticules, and a bottom surface having a lenticular image viewable through the top surface. A bonding agent is positioned between the top surface of said data substrate and the bottom surface of said lenticular substrate and then the substrates are bonded together.

In other embodiments of the invention, CD-R and CD-RW discs may be fabricated, wherein the structure includes a first translucent substrate, having a generally planar opposed top and bottom surfaces. The bottom surface is smooth and adapted to receiving an optical beam for accessing data on the disc. In the case of a CD-R a top surface of the first substrate has a photo-reactive dye coating formed thereon and in a CD-RW the top surface includes layers of chemicals, namely a phase change alloy sandwiched between dielectric layers. A reflective coating is formed on top of the photo-reactive dye, or chemical layers to enable the top surface to reflect light back to an optical reader. A bonding agent is disposed over the reflective coating and a second substrate is bonded to the first substrate wherein the second translucent substrate has a top surface incorporating a plurality of lenticules formed therein, and a bottom surface having interlaced strips of images forming the lenticular image printed thereon.

### BRIEF DESCRIPTION OF THE DRAWINGS

Features of the present invention will become more apparent upon reference to the drawings wherein:

FIG. 1 shows a flow chart diagram representative of the manufacturing process of the DVD-5 optical data disc;

FIG. 2 shows a cross sectional view of a prior art DVD-5 optical data disc;

FIG. 3 shows a cross-sectional view of a prior art CD optical data disc;

FIG. 4 shows a cross-sectional view of an optical data disc of the present invention;

FIG. 5 shows a flow-chart diagram representative of the process and method of manufacturing of the optical data disc of the present invention;

FIG. 6 is a graphical representation of the three dimensional lenticular effect on the optical disc surface manufactured in accordance with the present invention;

FIG. 7 is a perspective view of an emery case housing the optical-data disc;

FIG. 8 is a cross sectional side view of FIG. 7;

FIG. 9 is a perspective view of the emery case of FIG. 7 in an open position;

FIG. 10 shows a cross sectional view of a prior art CD-R optical data disc;

FIG. 11 shows a cross sectional view of a prior art CD-RW optical data disc;

FIG. 12 shows a cross sectional view of an optical data disc of the present invention employed in a CD-R configuration; and

FIG. 13 shows a cross sectional view of the optical data disc of the present invention utilizing a CD-RW configuration.

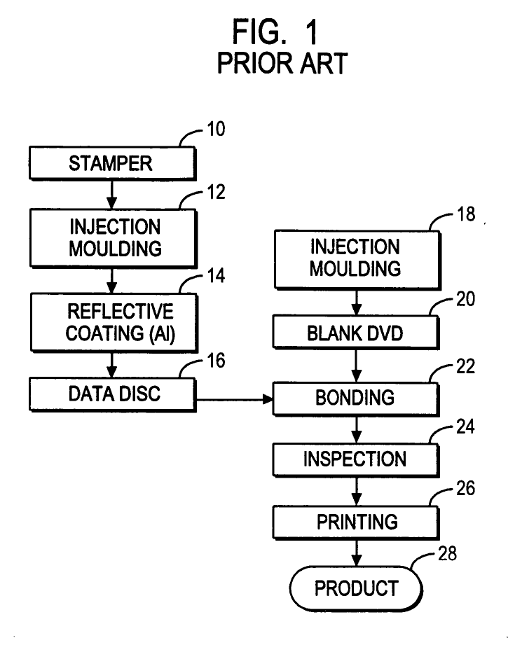

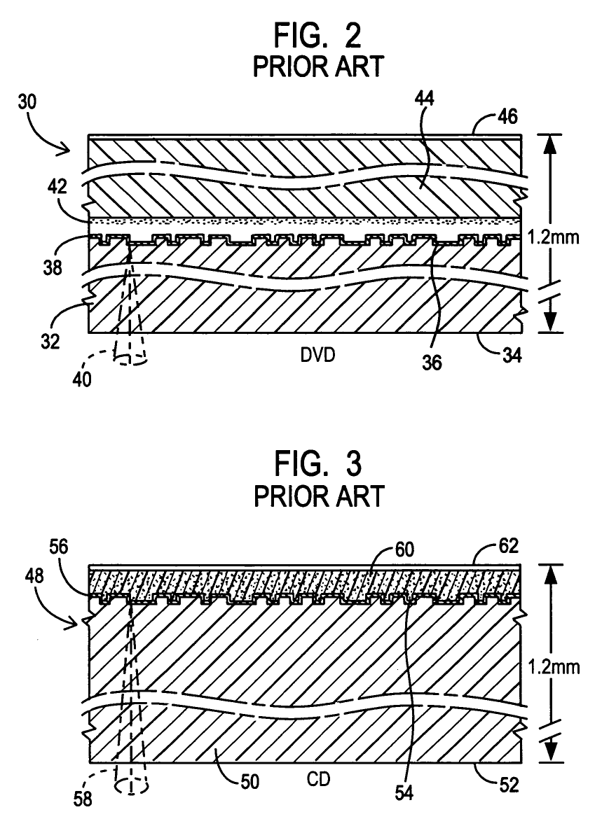

### DETAILED DESCRIPTION OF THE INVENTION

The detailed description as set forth below in connection with the appended drawings is intended as a description of the presently preferred embodiments of the present invention, and does not represent the only embodiment of the present invention. It is understood that various modifications to the invention may be comprised by different embodiments and are also encompassed within the spirit and scope of the present invention.

Lenticular printing and lenticular lenses are widely adapted for a variety of items such as signs, posters, collectibles, coasters, magnets, postcards and business cards. Lenticular technology is also used in packaging, publishing and labeling. Lenticular technology is particularly eye catching and draws attention to otherwise two dimensional graphics.

Lenticular images provide the user with an illusory effect of movement and three dimensional depth in the image. The effect is created by the combination of lenticular lenses (a series of lenticules) and underlying lenticular image. The lenticular image is typically a computer generated segmented image. The segmented image can be a series of images that are stripped and interlaced. The user looks through the lenticular lens and an image is assembled from the segmented interlaced images thus constructing a single image which has depth and/or appears to move depending on the visual angle. The lenticules may be cylindrical, pyramidal, trapezoidal or parabolic. Lenticular lenses are well known and commercially available. Methods for using lenticular lens technology are described in detail in U.S. Pat. Nos. 5,113,213 and 5,266,995, the disclosures of which are incorporated herein by reference.

The underlying lenticular images are a composite of two or more composite interlaced pictures and the lenticular lenses are arranged with the segmented portions to provide the desired image effect. The flat back surface of the lenses lays over the interlaced image and the image is viewed through the lenses sheet. Such lenticular image configurations are shown in U.S. Pat. Nos. 5,488,451; 5,617,178; 5,847,808 and 5,896,230, the disclosures of which are incorporated herein by reference.

Early lenticular technology used both the lenticular image and lenticular lenses as separate components. More recently, the lenticular image maybe incorporated directly on to the flat back surface of a lenticular sheet or film as taught in U.S. Pat. Nos. 5,457,515 and 6,424,467, the disclosure of which is incorporated herein by reference.

It should be understood in the discussion with respect to the present invention that lenticular imaging is distinct from holographic imaging. Holographic imaging utilizes a three dimensional image that is created using lasers. Because both holographic imagery and lenticular images can display depth, the terms are sometimes confused, but it should be understood that the holographic images and lenticular images are separate and distinct technologies. Holographic images do not employ lenticular lenses, but rather use etching as a means of creating a desired effect.

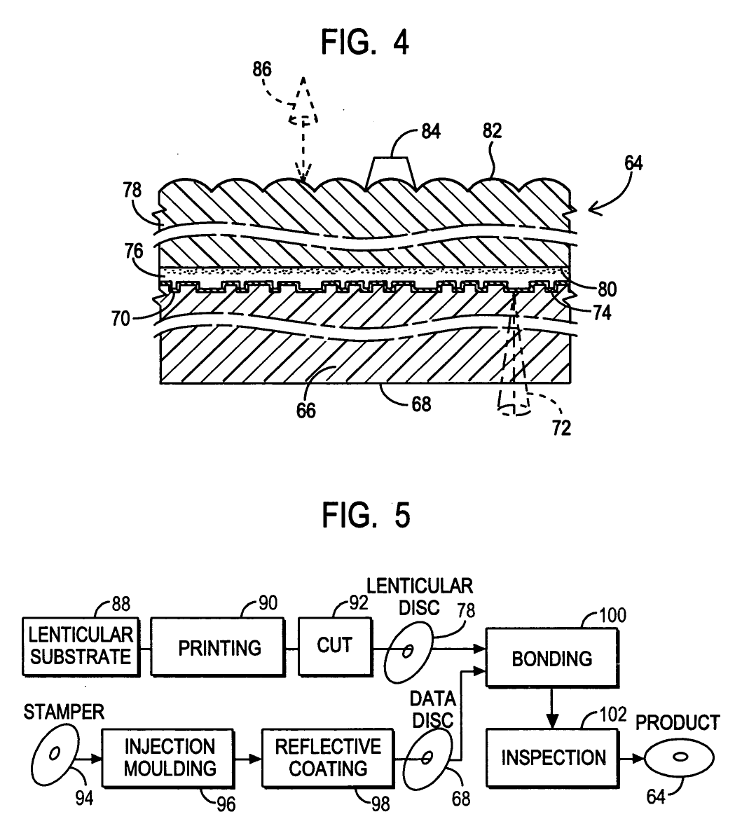

Referring particularly to FIG. 4, there is shown a cross section (not to scale) of the optical disc 64 of the present invention. The disc 64 comprises a first translucent substrate 66 having a generally planar bottom surface 68 and a top surface 70. The top surface 70 is formed through the injection molding stamping process to include pits that are representative of the recorded data on the disc. The translucent substrate 66 allows an optical beam 72 (shown in phantom); see FIG. 4) to project through the substrate 66. Because the top surface 70 is incapable of allowing an optical reader (not shown) to identify recorded data, the substrate must include a reflective coating layer 74 to be formed on the surface 70 to allow the optical beam 172 to reflect data back to an optical reader (not shown).

The substrate 66 is formed of polycarbonate, but may be formed of any suitable translucent plastic material such as polyester, vinyl, polycarbonate, polyvinyl chloride, polyethylene, terephthalate and/or amorphous polyethylene terephthalate. A bonding agent 76 is placed between the data disc substrate 66 and a lenticular substrate 78. The bonding agent 76 secures the lenticular substrate 78 to the data substrate 66. The bonding agent may be formed of any acceptable bonding agent used in a bonding process but preferably, the adhesive resin is a cationic UV-curable composition. For example, epoxy resins with a glycidyl ether group and a cationic photoioninitiator. Typically, epoxy resins with low chlorine content are preferred in order to prevent corrosion of the reflective layer 74.

The lenticular substrate 78 is generally translucent and has a planar bottom surface 80 and a top surface 82. The top surface 82 incorporates a plurality of lenticules 84 formed throughout the top surface. The substrate 78 is preferably formed from translucent polycarbonate but may be formed from any suitable plastic material such as but not limited to polyester, vinyl, polycarbonate, polyvinyl chloride, polyethylene terephthalate and amorphous polyethylene terephthalate. A lenticular image (not shown) may be formed onto the lenticular substrate 78 through a lithographic printing process. The image can be transferred to the substrate by any number of printing processes including but not limited to sheet-fed printing, web offset printing, flexographic printing, gravure printing, digital printing and electronic deposition printing. If the images are transferred by digital printing, such digital printing can comprise dye-sublimation printing, laser printing, electrostatic printing, ink jet printing and photographic emulsion. Thus, the eye of an observer 86 will look through the lenticular substrate 78 to an image (not shown) on the bottom surface 80 of the lenticular substrate 78. Thus, three dimensional art works or other identifying material is displayed on the top surface (non-recordable) of the optical disc. The optical disc structure as shown in FIG. 4 and as described herein may be utilized for both DVDs and CDs. The substrate 78 provides additional protection for the aluminum layer 74 in the underlying data surface 70, which is particularly problematic for today's existing CDs. Furthermore, the structure as described in FIG. 4 can be used to produce intricate images viewable through the substrate 78 which would be extremely difficult to reproduce, thus providing anti-counterfeiting protection for legitimate DVDs and CDs in the market place.

Referring particularly to FIG. 5, there is shown a flow chart diagram illustrating the method of forming a lenticular optical disc in accordance with the method of the present invention. A lenticular substrate 88, which is a lenticular sheet, is formed through any number of known processes. The lenticular substrate 88 has a lenticular image printed 90 onto the flat under surface. The printed lenticular substrate is then cut 92 into the conventional DVD and CD configuration such as a circular configuration. Although the present invention contemplates the use of lenticular technology with standard DVD and CD formats (i.e., circular) it is recognized that it may be used with oddly shaped optical media which are useable in today's DVD and CDs format sizing. In this regard, the shape of the optical media may be of any size that is operable with today's DVD and CD format. In addition, while the present format contemplates use with present day DVD and CD technology it is expected that a lenticular substrate layer maybe added to any format of optical media presently contemplated today, or as yet as to have been developed.

A stamper 94 is used in the injection molding process 96 to create a raw data disc with a polyurethane substrate. Although the present invention contemplates that the substrate 66 used in injection molding process 96 is formed from a polycarbonate, it is also contemplated that such substrate may be formed from any number of suitable plastic materials including but not limited to polyester, vinyl, polycarbonate, polyvinyl chloride, polyethylene terephthalate and amorphous polyethylene terephthalate. Because the pitted data surface 70 is incapable of transmitting data to an optical reader (not shown) a reflective coating is applied 98, thus completing a functional data disc, but with a raw aluminum surface exposed. Thus, the lenticular substrate/disc 78 and the data disc 66 are bonded by a bonding agent 76 through a hot melt bonding process 100. Bonding can be accomplished through UV bonding as well. Hot melt bonding and UV bonding are well known in DVD-5 fabrication. Once bonded, the disc is inspected 102 and a final product or optical data disc having lenticular qualities 64 is available for use by the consumer.

It is understood that lenticular disc 78 and the data disc 66 are approximately 0.60 mm in depth so that upon bonding and hot melt bonding process 100 a standard DVD-5 data disc having a depth of approximately 1.2 mm is produced. It is understood and contemplated that although typically CDs are produced on substrates of approximately 1.2 mm in depth, the process for the present invention contemplates use of two substrates each 0.60 mm in depth.

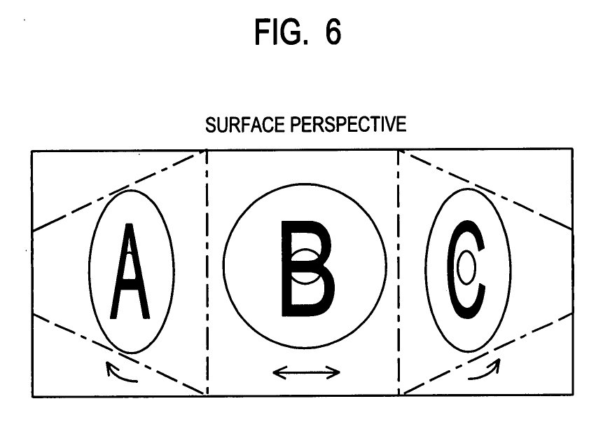

The resulting product is demonstrated as shown in FIG. 6 which illustrates a top view of the lenticular image 90 as the lenticular image 90 is being viewed through the lenticular substrate 88. More particularly, FIG. 6 illustrates that image A, B, and C may be selectively and separately viewed through the lenticular substrate 88 as the product is rotated from left to right, respectively. In other words, image A may be viewed when the product is viewed from the left side, image B may be viewed when the product is viewed straight forward, and image C may be viewed when the product is viewed from the right side. This is merely illustrative of an aspect of the present invention and is not meant to limit the same. For example, more than three images may be viewed as the product is rotated from left to right. These images may also be viewed in sequence as the product is rotated from right to left. Additionally and alternatively, the image(s) may be viewed selectively and separately as the product is rotated from top to bottom.

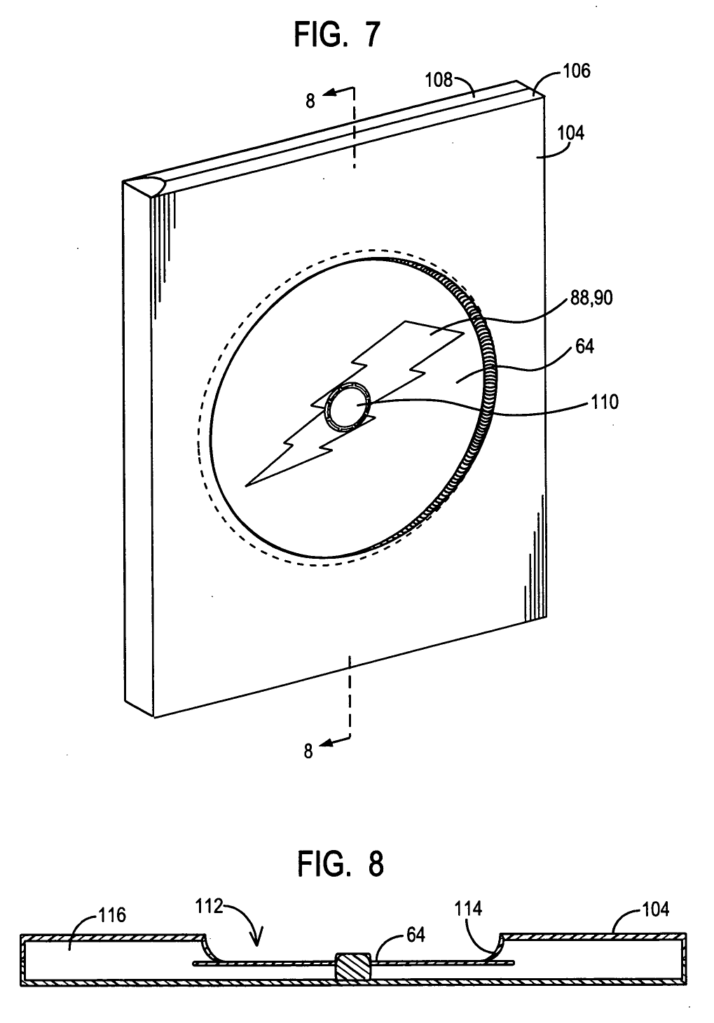

Referring particularly to FIGS. 7-9, it is contemplated by the present invention that the optical disc 64 because of its unique and stunning imagery may be displayed through the jewel case, emery case or other packaging 104 in which an optical disc 64 is sold. Accordingly, that disc 64 may reduce costs in manufacturing and labeling as the disc 64 itself may be used as the featured artwork. In other words, a label or insert for the case 104 which serves the purpose of identification of the disc 64 and marketing for the disc 64 does not have to be produced. Rather, the lenticular image 90 viewed through the lenticular substrate 88 serves these purposes.

As stated above, the aspects of the present invention, namely, a lenticular image 90 and lenticular substrate 88 attached to a translucent substrate 66 may be utilized as an anti-counterfeiting mechanism. Moreover, a case such as an emery case or a jewel case 104 may be modified such that the lenticularized image 90 may be viewed even when the case 104 is in a closed position (see FIG. 7).

The aspects of the present invention may be useful to prevent counterfeiting of CDs and DVDs. As a first example, anti-counterfeiting information may be embedded within the lenticular image 90 such that the anti-counterfeiting information is viewable through the lenticular substrate 88 at an angle that is different compared to its normal consumer usage. In particular, if the normal consumer views the lenticular image 90 by rotating the products from left to right then anti-counterfeiting information may be embedded and interlaced with the image 90 to be viewed by the consumer such that the anti-counterfeiting information is viewable at a vertical angle of 45 degrees. In other words, the anti-counterfeiting information is not viewable during the normal usage of the products. This may be accomplished by placing or interlacing the anti-counterfeiting information at a pitch slightly offset from the pitch of the lenticular image 90 to be viewed by the consumer. In this way, as long as the existence of the anti-counterfeiting information and the angle at which the anti-counterfeiting information may be viewed is maintained with secrecy, a counterfeiter would not incorporate the anti-counterfeiting information in the counterfeit version of the disc.

The anti-counterfeiting information may also be, in the alternative, embedded in the lenticular image 90 such that the anti-counterfeiting information may be viewed at an angle at which the consumer may view the lenticular image 90 during the products normal usage. In this regard, the anti-counterfeiting information may be an indistinguishable variation of the lenticular image such that the counterfeiter would not be cognizant of the anti-counterfeiting information upon viewing the lenticular image 90 through the lenticular lenses 88. For example, if the lenticular image 90 comprised of four frames of dolphins swimming in the ocean, then the anti-counterfeiting information may be a non-natural wrinkle of a wave in the lenticular image 90. By this way, the counterfeiter would attempt to copy the dolphins and its environment and would not be cognizant of the wrinkle. In this regard, as long as the existence of the anti-counterfeiting information is maintained with secrecy, the counterfeiter would not incorporate the anti-counterfeiting information into the lenticular image 90. Moreover, the counterfeiter would not be able to copy the lenticular image 90 directly from an authentic product to thereby inadvertently incorporate the anti-counterfeiting information in the copied disc. The reason is that the resolution of the lenticular image 90 through the lenticular lenses 88 is lower than the resolution of the lenticular image 90 viewed directly and not through the lenticular lenses 88. Additionally, the counterfeiter would not be able to remove the lenticular image 90 from the bottom surface 80 of the second substrate 78 because of the method by which the lenticular image 90 is attached to and applied to the bottom surface 80 of the lenticular substrate 78.

The lenticular disc of the present invention is particularly resistant to counterfeiter duplication because it is difficult, if not impossible, to separate the lenticular substrate 78 to expose the lenticular image 90. Furthermore, the image 90 cannot be effectively scanned through the lenticular substrate 78 through any known scanning equipment or process. Accordingly, a lenticular image which is created from a series of video frames is incapable of being reproduced, unless the counterfeiter has direct access to the original video frame. In this regard, a record company or recording artist could effectively create a video or film segment which would not be released to the general public, and would thus serve as the verification images for purposes of counterfeit protection.

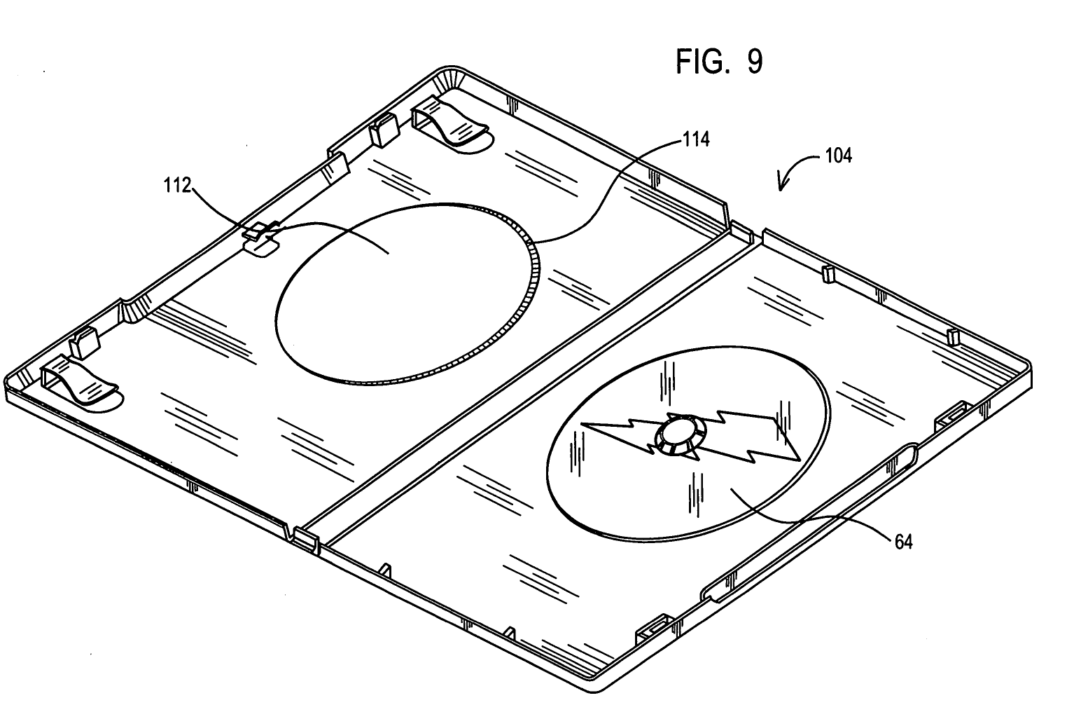

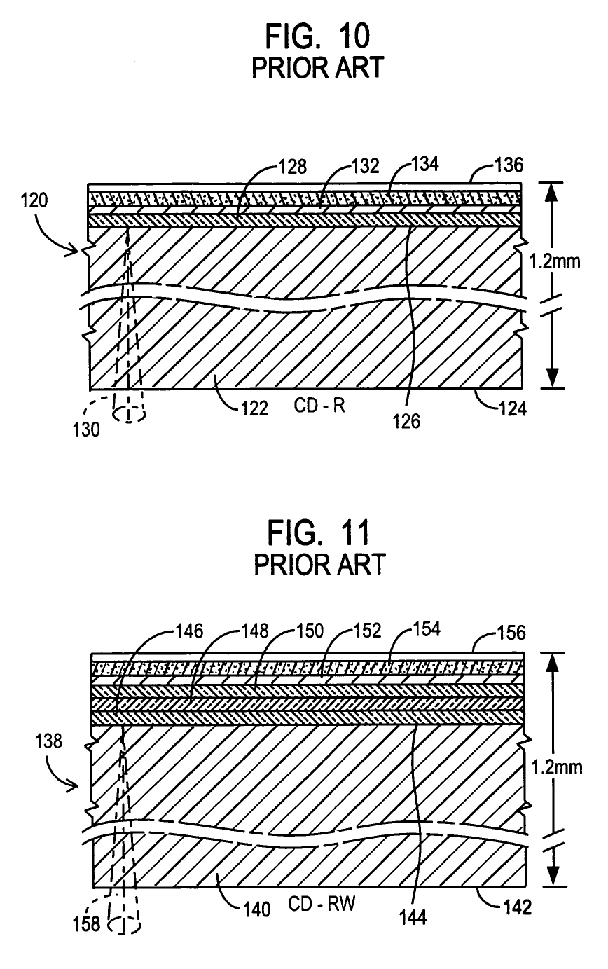

In another aspect of the present invention, the CD or DVD which has the lenticular image 90 and lenticular substrate 88 applied thereto may be viewed through a modified emery case or jewel case 104, or any suitable case to encompass, enclose or hold the product (see FIG. 7). For purposes of illustrating the present invention and not for limiting the same, an emery case similar to the emery case disclosed in Mou et al (U.S. Pat. No. 6,398,022) will be used to illustrate various aspects of the present invention. The contents of Mou et al. are incorporated herein by reference. The emery case 104 may be comprised of a left flap 106 and a right flap 108. The right flat 108 may additionally have a post 110 directed to an inner cavity of the emery case 104. The post 110 may be operative to retain the CD or DVD on the post 110 and correspondingly the CD or DVD within the emery case 104. The left flap 106 may have an aperture 112 (see FIGS. 8 and 9) such that when the left and right flaps 106, 108 are in a closed position, the CD or DVD is viewable through the aperture 112. In the invention as shown, the diameter of the aperture 112 is less than the diameter of a disc 64, in order to retain the disc 64 within the packaging 104. It is contemplated that the entire package could be shrink wrapped for additional security

The CD or DVD may have various configurations such as circular, triangular, or trapezoidal. These configurations are merely illustrative of the configurations of which the CD or DVD may have and are not meant to limit the various configurations which the CD or DVD may have. Correspondingly, the aperture 112 may have a respective configuration with respect to the CD configuration. For example, if the CD had a triangular configuration, then the aperture 112 may have a triangular configuration. Moreover, the aperture 112 may further have a flange 114 which is directed towards the inner cavity 116 of the case 104. The flange 114 may be operative to apply pressure to the CD or DVD when the CD or DVD is enclosed within the case 104.

This unique modification to the case serves two purposes, mainly, an anti-counterfeiting protection mechanism and a decorative function. With respect to the former, anti-counterfeiting information may be embedded within the lenticular image 90 in the manner discussed above. Accordingly, the anti-counterfeiting information may be utilized in the manner discussed above because the anti-counterfeiting information may be viewable through the aperture 112. With respect to the latter, the consumer may be able to view the lenticularized image 90 through the aperture 112 which may be the preferred placement of the lenticularized image 90 based on a view that the CD or DVD is the true product which the consumer is purchasing. In other words, consumers would prefer the true product to be marketably appealing instead of the case 104 that houses the true product.

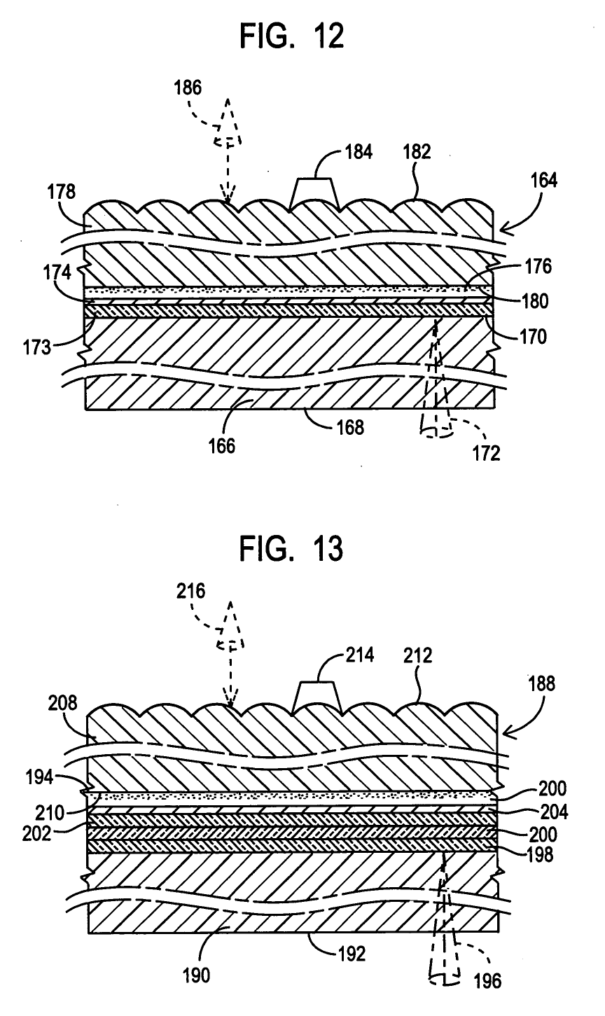

Referring to FIG. 12, there is shown a cross section (not to scale) of the optical data disc 164 of the present invention employing CD-R technology. The disc 164 comprises a first translucent substrate 166 having a generally planar bottom surface 168 and top surface 170. The translucent substrate 166 allows an optical beam 172 (shown in phantom) to project through the substrate 166. A photo-reactive dye 173 is spun across the surface 170. An aluminum reflective coating layer 174 is formed over the dye 174 to allow the optical beam 172 to reflect back to an optical reader (not shown).

Substrate 166 is preferably formed of polycarbonate. A bonding agent 176 is placed between the aluminum layer 174 and a lenticular substrate 178. The bonding agent 176 affixes the lenticular substrate 178 to the data substrate 166. The boding is completed using UV bonding. Hot melt bonding may be used as well.

The lenticular substrate 178 is generally translucent and has a planar bottom surface 180, and a top surface 182. The top surface 182 incorporates a plurality of lenticules 184 formed throughout the top surface. A lenticular image (not shown) may be formed onto the lenticular substrate 178. Thus, the eye of the observer 186 will look through the lenticular substrate 178 to an image (not shown) on the bottom surface 180 of the lenticular substrate 178. Thus, three dimensional art works or other identifying material is displayed on the top surface (non recordable) of the optical disc 164.

Referring to FIG. 13, there is shown a cross section (not to scale) of the optical data disc 188 of the present invention employing CD-RW technology. The disc 188 comprises a first translucent substrate 190 having a generally planar bottom surface 192 and top surface 194. The translucent substrate 190 allows an optical beam 196 (shown in phantom) to project through the substrate 190. The data surface 194 is layered with a dielectric 198 (zinc sulfide and silicon dioxide). Above the dielectric layer 198, a layer of phase change alloy recording layer 200 (indium, silver, tellerium and antimony) is placed. Above the phase change recording layer 200, a second dielectric layer 202 is provided. The chemical layers 198, 200 and 202 are coated with a thin aluminum reflective layer 204. The aluminum reflective coating layer 204 is formed over the chemical layers to allow the optical beam 196 to reflect back to an optical reader (not shown) or to create a photo-reaction in the chemicals 198, 200 and 202 to either burn data onto the CD, or erase data.

Substrate 208 is preferably formed of polycarbonate. A bonding agent 206 is placed between the aluminum layer 204 and the lenticular substrate 208. The bonding agent 206 affixes the lenticular substrate 208 to the data substrate 190. The boding is completed using UV bonding. Hot melt bonding may be used as well.

The lenticular substrate 208 is generally translucent and has a planar bottom surface 210, and a top surface 212. The top surface 212 incorporates a plurality of lenticules 214 formed throughout the top surface. A lenticular image (not shown) may be formed onto the lenticular substrate 208. Thus, the eye of the observer 216 will look through the lenticular substrate 208 to an image (not shown) on the bottom surface 210 of the lenticular substrate 208. Thus, three dimensional art works or other identifying material is displayed on the top surface (non recordable) of the optical disc 188.

It should be noted and understood that with respect to the embodiments of the present invention, the materials suggested may be modified or substituted to achieve the general overall resultant high efficiency. The substitution of materials or dimensions remains within the spirit and scope of the present invention.

1. An optical data medium incorporating lenticular imaging, comprising:
a first translucent substrate having generally planar opposed top and bottom surfaces, said bottom surface for receiving an optical beam;
a photo-reactive dye coating formed on said top surface of said first substrate;
a reflective coating formed over said photo-reactive dye coating;
a second translucent substrate having generally planar top and bottom surfaces, said bottom surface for bonding with a layer of bonding agent and said top surface having a plurality of lenticules; and
the layer of a bonding agent disposed between the reflective coating and the bottom surface of said second substrate, the bonding layer securing the first substrate to the second substrate.

2. The optical data medium of claim 1 wherein said second translucent substrate bottom surface incorporates a lenticular image.

3. The optical data medium of claim 2 wherein said lenticular image is formed onto said second substrate through lithographic printing.

4. The optical data medium of claim 2 wherein said lenticular image is formed onto said second substrate by one of: sheet-fed printing, web offset printing, flexographic printing, gravure printing, digital printing and electronic deposition printing.

5. The optical data medium of claim 4 wherein said digital printing comprises one of: dye sublimation printing, laser printing, electrostatic printing, ink jet printing and photographic emulsion.

6. The optical data medium of claim 1 wherein said first substrate is polycarbonate.

7. The optical data medium of claim 1 wherein said first substrate is manufactured of a plastic material of the group consisting of polyester, vinyl, polycarbonate, polyvinyl chloride, polyethylene terephthalate and amorphous polyethylene terephthalate.

8. The optical data medium of claim 1 wherein said second substrate is polycarbonate.

9. The optical data medium of claim 1 wherein said second substrate is manufactured of a plastic material of the group consisting of polyester, vinyl, polycarbonate, polyvinyl chloride, polyethylene terephthalate and amorphous polyethylene terephthalate 10.

10. The optical data medium of claim 1 wherein said plurality of lenticules each having a focal length.

11. The optical data medium of claim 10 wherein said second substrate incorporates a lenticular image at the focal length of said plurality of lenticules.

12. A method of fabricating an optical data medium incorporating lenticular imaging comprising the steps of:
providing a data substrate having generally planar opposed top and bottom surfaces, said bottom surface for receiving an optical beam, and said top surface having at least one photo-reactive chemical disposed thereon;
providing a lenticular substrate having generally planar top and bottom surfaces, said top surface having a plurality of lenticules;
positioning a bonding agent between the top surface of said data substrate and the bottom surface of said lenticular substrate; and
bonding said data substrate to said lenticular substrate.

13. The method of claim 12 wherein said bonding step comprises a hot melt bonding process.

14. The method of claim 12 wherein said bonding step comprises a UV bonding process.

15. The method of claim 14 wherein said UV bonding step comprises a radical UV cured bonding.

16. The method of claim 14 wherein said UV bonding step comprises a cationic UV bonding.

17. An optical data disc incorporating anti-counterfeiting imaging comprising:
a first translucent substrate having generally planar opposed top and bottom surface, said bottom surfaces for receiving an optical beam;
a photo-reactive dye coating formed on said top surface of said first substrate;
a reflective cation formed over said photo-reactive dye coating;
a second translucent substrate having generally planar top and bottom surface, said bottom surface incorporating a lenticular image having anti-counterfeiting information, and said bottom surface for bonding with a bonding agent and said top surface having a plurality of lenticulars; and
a layer of a bonding agent disposed between the reflective coating and the bottom surface of said second substrate, the bonding layer securing the first substrate to said second substrate.

18. The disc of claim 17 wherein said lenticular image also includes a customer oriented image.

19. The disc of claim 18 wherein the anti-counterfeiting information is viewable from a different angle compared to the customer oriented image through the top surface of the second translucent substrate.

20. The disc of claim 17 wherein the anti-counterfeiting information is a series of images viewable through corresponding angles and the first and second translucent substrates have symmetrical and corresponding outer perimeters.

21. A method of fabricating an optical data disc incorporating anti-counterfeiting lenticular imaging comprising the steps of:
providing a data substrate having generally planar opposed top and bottom surfaces, said bottom surface for receiving and optical beam and said top surface having at least one photo-reactive chemical disposed thereon;
providing a lenticular substrate having a generally planar top and bottom surfaces, said top surface having a plurality of lenticules and said bottom surface having lenticular anti-counterfeiting information;
positioning a bonding agent between the top surface of the said data substrate and the bottom surface of said lenticular substrate; and
bonding said data substrate to said lenticular substrate.

22. The method of claim 21, wherein said bonding comprises a hot melt bonding process.

23. The method of claim 21 wherein said bonding step comprises a UV bonding process.

24. The method of claim 23 wherein said UV bonding step comprises a radical UV cured bonding.

25. The method of claim 23 wherein said UV bonding step comprises a cationic UV bonding.

26. An optical data medium incorporating lenticular imaging, comprising:
a first translucent substrate having generally planar opposed top and bottom surfaces, said bottom surface for receiving an optical beam, and said top surface having at least one photo-reactive chemical formed thereon with a reflective surface;
a second translucent substrate having generally planar top and bottom surfaces, said bottom surface for bonding with a layer of bonding agent and said top surface having a plurality of lenticules; and
the layer of a bonding agent disposed between the reflective surface of the first substrate and the bottom surface of said second substrate, the bonding layer securing the first substrate to the second substrate.

27. A display case for housing and displaying an optical data medium comprising:
an optical data medium, releasably engageable with said case, said medium comprising:
a first substrate having a plurality of lenticules on a viewing surface and a lenticular image printed on an opposed surface;
a second substrate having a photo-reactive chemical formed thereon; and
wherein said first and second substrates are bonded to form a data medium having a lenticular image viewable thereon;
a housing for enclosing said optical data medium, said housing including an aperture for displaying at least a portion of said optical data medium.

28. A method of fabricating an optical data medium incorporating lenticular imaging comprising the steps of:
providing a data substrate having generally planar opposed top and bottom surfaces, said bottom surface for receiving an optical beam, and said top surface having at least one photo-reactive chemical disposed thereon;
providing a lenticular substrate having generally planar top and bottom surfaces, said top surface having a plurality of lenticules;
positioning a bonding agent between the top surface of said data substrate and the bottom surface of said lenticular substrate; and
bonding said data substrate to said lenticular substrate using a UV bonding process.

29. The method of claim 14 wherein said UV bonding step comprises a radical UV cured bonding.

30. The method of claim 14 wherein said UV bonding step comprises a cationic UV bonding.
